(19) United States
(12) Patent Application Publication
(10) Pub. No.: US 2017/0236071 A1
(43) Pub. Date: Aug. 17, 2017

(54) ALARM MANAGEMENT SYSTEM

(71) Applicant: Freeport-McMoRan Inc., Phoenix, AZ (US)

(72) Inventors: Mary Amelia Walker, Phoenix, AZ (US); D. Bradley Brown, Phoenix, AZ (US)

(21) Appl. No.: 15/426,795

(22) Filed: Feb. 7, 2017

Related U.S. Application Data
(60) Provisional application No. 62/294,032, filed on Feb. 11, 2016.

(51) Int. Cl. G06N 99/00; G08B 29/18

(52) U.S. Cl. CPC G06N 99/005; G08B 29/18

(57) ABSTRACT

A method of classifying machine alarms produced by a machine monitoring system may include: Collecting a plurality of machine alarms from the machine monitoring system, the machine alarms being indicative of out-of-range machine system parameters; collecting a plurality of alarm annotations associated with at least some of the machine alarms; grouping the plurality of machine alarms by criticality; determining a strength of alarm annotations; and developing an alarm classification policy for machine alarms based at least on the criticality of the alarms and the strength of the alarm annotations.

### CROSS-REFERENCE TO RELATED APPLICATION

This application claims the benefit of U.S. Provisional Patent Application No. 62/294,032, filed on Feb. 11, 2016, which is hereby incorporated herein by reference for all that it discloses.

### TECHNICAL FIELD

The present invention relates to machine monitoring systems in general and more particularly to systems and methods of classifying machine alarms to permit more efficient machine operation.

### SUMMARY OF THE INVENTION

One embodiment of a method of classifying machine alarms produced by a machine monitoring system may include the steps of: Collecting a plurality of machine alarms from the machine monitoring system, the machine alarms being indicative of out-of-range machine system parameters; collecting a plurality of alarm annotations associated with at least some of the machine alarms; grouping the plurality of machine alarms by criticality; determining a strength of alarm annotations; and developing an alarm classification policy for machine alarms based at least on the criticality of the alarms and the strength of the alarm annotations.

Also disclosed is a non-transitory computer-readable storage medium having computer-executable instructions embodied thereon that, when executed by at least one computer processor cause the processor to: Collect a plurality of machine alarms from the machine monitoring system, the machine alarms being indicative of out-of-range machine system parameters of the machine; collect a plurality of alarm annotations associated with at least some of the machine alarms; group the plurality of machine alarms by criticality; determine a strength of alarm annotations; and develop an alarm classification policy for machine alarms based at least on the criticality of the alarms and the strength of the alarm annotations.

A method of operating a machine having a machine monitoring system that produces machine alarms indicative of out-of-range machine system parameters may include: Receiving machine alarms from the machine monitoring system; classifying the machine alarms based on a predetermined alarm classification system for the machine, the predetermined alarm classification system being based on criticality of representative samples of machine alarms and strength of representative samples of alarm annotations; and managing the subsequent operation of the machine based on the alarm condition category.

Also disclosed is a system for classifying machine alarms produced by a machine monitoring system that includes a network operatively connected to the machine monitoring system. A processing system is also operatively connected to the network and is configured to: Receive machine alarms from the machine monitoring system, the machine alarms being indicative of out-of-range machine system parameters of the machine; classify the machine alarms based on a predetermined classification system, the predetermined classification system being based on criticality of representative samples of machine alarms and strength of representative samples of alarm annotations; and display the classified machine alarms on a display system connected to the processing system.

Also disclosed is a non-transitory computer-readable storage medium having computer-executable instructions embodied thereon that, when executed by at least one computer processor cause the processor to: Receive machine alarms from a machine monitoring system, the machine alarms being indicative of out-of-range machine system parameters of a machine; classify the machine alarms based on a predetermined classification system, the predetermined classification system being based on criticality of representative samples of machine alarms and strength of representative samples of alarm annotations; and display the classified machine alarms on the display system.

### BRIEF DESCRIPTION OF THE DRAWINGS

Illustrative and presently preferred exemplary embodiments of the invention are shown in the drawings in which:

FIG. 1 is a schematic representation of one embodiment of a system for classifying machine alarms according to the teachings of the present invention;

FIG. 2 is a flow chart of one embodiment of a method of classifying machine alarms; and

FIG. 3 is a flow chart of one embodiment of a method of classifying new machine alarms in accordance with a defined alarm classification system.

### DETAILED DESCRIPTION OF THE PREFERRED EMBODIMENTS

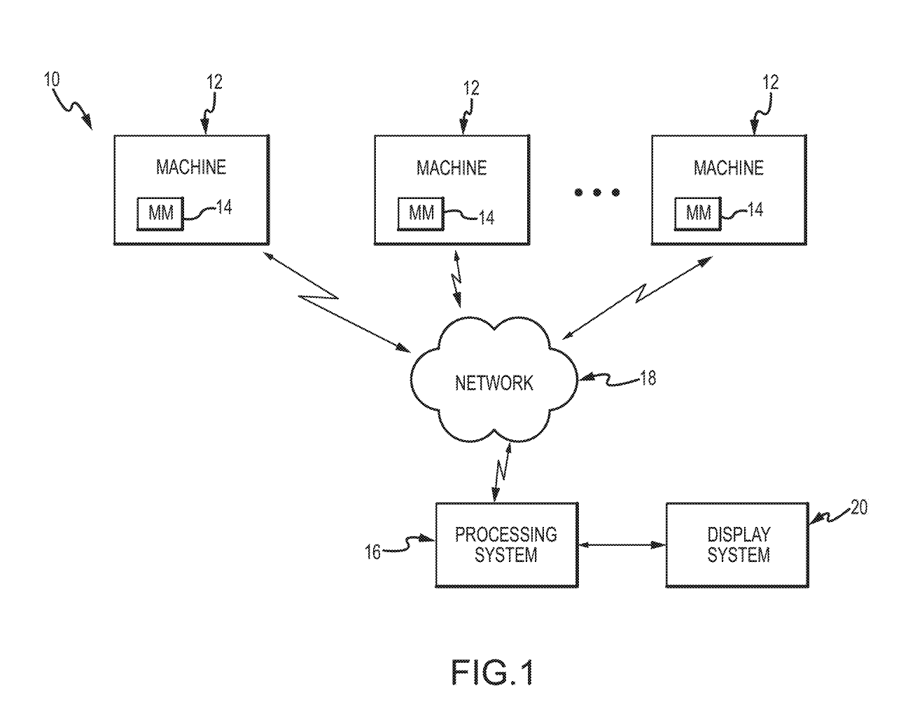

One embodiment of a system 10 for classifying machine alarms is illustrated in FIG. 1 as it could be used in conjunction with one or more mining machines 12, such as haul trucks, dozers, shovels, or other types of machines commonly used in mining operations. Each mining machine 12 may be provided with a machine monitoring system 14 for monitoring one or more systems of the machine 12, such as engine systems, suspension systems, hydraulic systems, and the like. As will be explained in further detail herein, the machine monitoring system 14 may produce a machine alarm if one or more parameters of the monitored machine system experiences an out-of-range condition, although they may be generated or produced in response to other operational conditions or circumstances.

The machine alarm classification system 10 may also comprise a processing system 16. Processing system 16 may be operatively connected, e.g., via a wireless network 18, to the machine monitoring systems 14 of the various mining machines 12. Processing system 16 also may be operatively connected to one or more display systems 20. The display system 20 may be used to display certain information and data relating to alarm conditions of the mining machines 12.

As will be described in further detail below, the processing system 16 may be programmed or configured to operate in accordance with at least a method 22 and a method 34 to develop an alarm classification policy and to subsequently use the alarm classification policy to classify new alarms generated by the machine monitoring systems 14. In the particular embodiments shown and described herein, the systems and methods of the present invention significantly reduce the number of machine alarms classified as ‘critical.’ That is, most machine monitoring systems are programmed or configured to generate machine alarms when one or more monitored parameters or systems experience one or more out-of-range conditions. While such machine monitoring systems may be capable of distinguishing between the criticality of the out-of-range conditions (e.g., by producing ‘critical’ and ‘non-critical’ alarms), the distinctions applied by the machine monitoring system may or may not be applicable to the particular situation or environment in which the machine is to be used. As a result, it is often the case that the distinctions applied by the machine monitoring system are not particularly appropriate for the particular operating environment.

By reducing the number of machine alarms classified as ‘critical,’ the alarm management system 10 allows the system operators to more tightly focus their attentions on those machine alarms that may have an immediate and substantive impact on operations, rather than being distracted by ‘critical’ alarms (as may have been previously classified by the machine monitoring system 14) that are not really critical or that may not have an immediate and substantive impact on operations.

Another significant feature of the systems and methods of the present invention is that they may be used to develop several gradations or categories of alarm condition categories. For example, in one embodiment, the present invention may be used to classify the alarm conditions into one of five separate alarm condition categories, ranging from ‘critical’ to ‘informational,’ thereby permitting system operators to more effectively manage machine operations based on the type of alarm received. More specifically, machine alarms classified as ‘critical’ will require different management steps (e.g., in terms of timeliness and responsiveness), compared with machine alarms that are categorized as merely ‘informational.’ Consequently, the present invention will provide significant opportunities in terms of efficiency and cost reduction compared with systems that simply rely on the alarms produced by the machine monitoring systems 14 of the various machines 12.

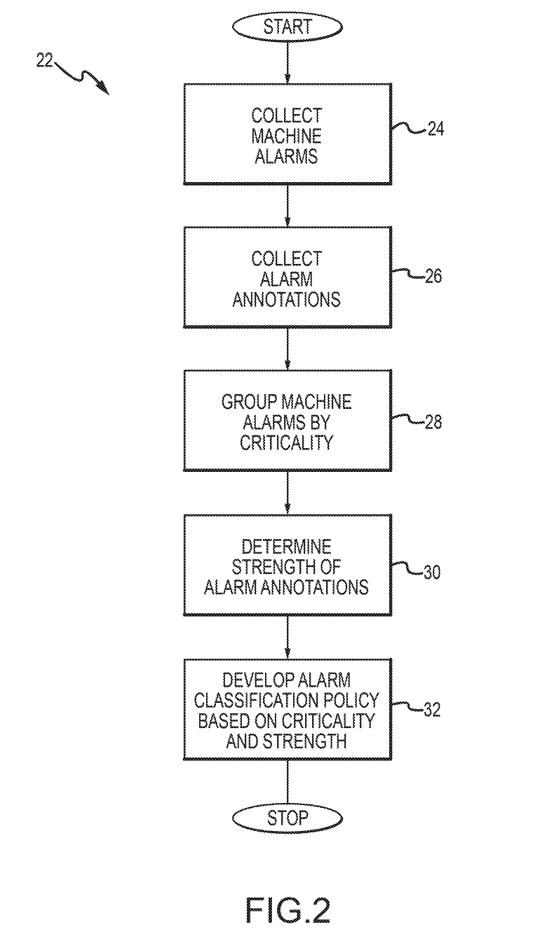

Continuing now with the description, and with reference now to FIG. 2, in one embodiment processing system 16 may implement method 22 to develop an alarm classification policy. The alarm classification policy may be used to organize or classify the machine alarms produced by the machine monitoring systems 14 into various alarm condition categories.

A first step 24 in method 22 involves the collection of a plurality of machine alarms. The collected machine alarms may comprise historical (i.e., past) machine alarm data produced by the machine monitoring system 14 of one or more mining machines 12. Alternatively, the collected machine alarms may comprise current machine alarm data. A next step 26 of method 22 involves the collection of alarm annotations. Alarm annotations may be notations separately made or developed by machine operators or maintenance specialists that relate to the nature, type, or severity of the alarm condition or maintenance steps or operations that may be required as a consequence of the alarm condition. Alarm annotations may also include information produced by the machine monitoring system 14 itself, e.g., as may be programmed into the machine monitoring system 14 by the machine manufacturer.

Once the various data have been collected regarding the machine alarms and the alarm annotations that may be correlated with each machine alarm, method 22 then proceeds to step 28 in which the machine alarms are grouped by criticality. In one embodiment, a k-means clustering algorithm is used to group the machine alarms by criticality. K-means clustering algorithms are well-known in the art and may be used to classify or group objects into a small number (i.e., ‘k’) of clusters based on certain attributes or features of those objects. In a typical k-means clustering algorithm, the grouping is done by minimizing the sum of the squares of distances between data and the centroid of the corresponding cluster. In separate embodiments other mathematical algorithms may be used to group the machine alarms by criticality, according to the relevant characteristics of the particular set of machine alarms.

The next step 30 of method 22 involves a determination of the strength of the alarm annotations for the various machine alarms. The strength of the alarm annotations may be developed or determined by a sentiment analysis algorithm. The sentiment analysis algorithm analyzes the alarm annotations and assigns a sentiment score to them. Alarm annotations having a high sentiment score are deemed to be of a high or significant strength, whereas alarm annotations having a low sentiment score are deemed to be of low or weak strength. In one embodiment, the sentiment analysis algorithm analyzes the text of the alarm annotations in order to determine the sentiment score. Optionally, the alarm annotations may be subjected to a word cloud analysis algorithm to determine the frequencies of words used in the alarm annotations. The word cloud analysis may be used to refine the sentiment score applied to the alarm annotations.

After having grouped the machine alarms by criticality, i.e., in step 28, and after having determined the strength of the alarm annotations, i.e., in step 30, method 22 then proceeds to step 32, which involves the development of the alarm classification policy based on the criticality of the alarm conditions and strength of the alarm annotations.

After having been developed, the alarm classification policy may be subjected to an expert input process in which machine operators or others knowledgeable about the function and operation of the various machines and/or how they are used in the particular production operation may review and/or modify the alarm classification policy to change the alarm condition category for any particular alarm condition. For example, an alarm condition that was originally designated as being in the ‘warning’ category may be re-classified into the ‘critical’ category if it is believed, e.g., based on the expert input, that the particular alarm condition is really of a critical nature, rather than of a warning nature. The expert input process may comprise an iterative process in which the classification of one or more specific machine alarms may be re-categorized from the alarm condition category in the original alarm classification policy.

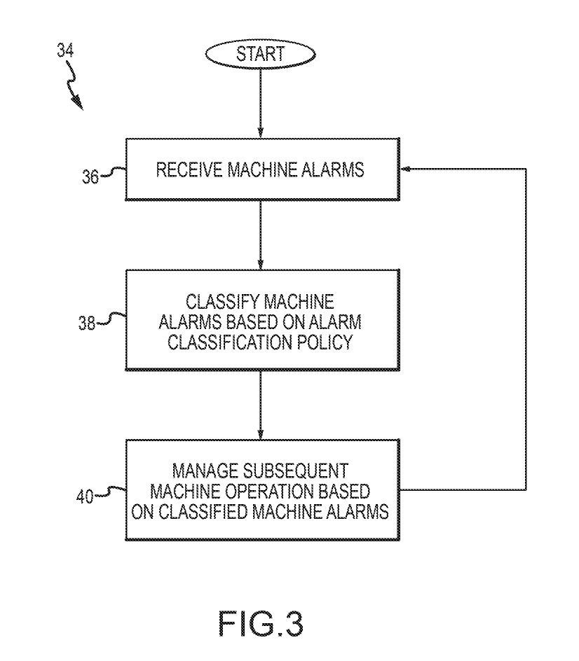

After the alarm classification policy has been created and/or subjected to the expert input process, it may be used in subsequent machine operations to classify newly-generated machine alarms into the defined alarm condition categories of the alarm classification policy. For example, and with reference now primarily to FIG. 3, the processing system 16 may follow method 34 in which new machine alarms are processed in accordance with the alarm classification policy developed by method 22.

A first step 36 in process 34 involves receiving machine alarms from the machine monitoring systems 14 of the various machines 12. In most embodiments, the machine monitoring systems 14 may be configured to send (e.g., via wireless network 18) information on machine alarms on a substantially continuous basis. Those machine alarms are then received by processing system 16 at step 36. Processing system 16 then classifies, at step 38, the machine alarms based on the alarm classification policy previously developed. Thereafter, the reclassified alarms may be presented on display system 20 for consideration and evaluation by system operators. The system operators may then manage, at step 40, subsequent operations of the machine based on the reclassified alarms. The process 34 may be repeated so long the machine monitoring systems 14 are active and may generate machine alarms.

As mentioned, the alarm classification system 10 significantly reduces the number of alarm conditions requiring immediate attention, thereby relieving system operators of the heretofore significant burden of trying to understand the machine alarms and distinguish those alarm conditions that should be attended to immediately from other alarm conditions of reduced priority. The alarm classification system 10 may substantially increase the likelihood that a critical alarm is recognized and dealt with before damage occurs to a mining machine 12, while simultaneously decreasing the likelihood that non-critical or mundane alarms unnecessarily interfere with mining machine 12 tasks and daily mine output.

Having herein described various aspects of the machine alarm classification system 10, the method 22 to develop an alarm classification policy, and the method 34 which may be employed by processing system 16 to classify and process new machine alarms according to a known classification policy, the following example embodiment is provided of a mining company utilizing the system 10 and method 22 in action to reduce the number of critical alarms and better divide the body of remaining alarms into manageable classification categories.

In this example embodiment, the company operated a fleet of mining machines 12, each of which contained an onboard machine monitoring system 14 which generated up to 45 alarms per vehicle per day. Before implementing the machine alarm classification system 10, this volume of monitoring systems 14 generated 87,661 total occurrences of 82 separate critical alarms within a given time period. Also during this time period, the monitoring systems 14 generated an additional 430,869 total occurrences of 276 separate non-critical warning alarms (requiring inspection at the earliest opportunity). The goal of implementing the machine alarm classification system 10 on this body of data was to utilize a data driven approach to compare alarm criticality and to reduce the number of alarms classified as ‘critical,’ without impairing the quality of alarm reporting or preventing important alarms from reaching the attention of system operators.

The company began the aforementioned method 22 at step 24 with the collection of a plurality of machine alarm records. Data were available in the form of dispatch status event records and onboard mining machine 12 memory records; in other embodiments, other sources of information may be used to supply alarm information. At this time, the mining company also performed step 26 and collected alarm annotations, which were stored in a similar fashion to the machine alarm data. The company cleaned the available data by eliminating duplicate and null annotation records, extremely rare and inconsequential alarms, non-relevant user-defined event annotations, and alarms that only occurred at non-relevant mining sites or time periods. In this particular embodiment, the data cleaning reduced the total volume of alarm occurrences from 518,530 to 491,325. Other embodiments of the method 22 may employ alternate criteria to clean the resulting data, as would be pertinent to those specific embodiments.

Next, the company grouped the remaining alarms by criticality as per method 22 step 28. The alarm data were imported into a data mining and analysis software package, which permitted grouping according to the following five separate variables:
1. Average Number of Trucks/Month: More critical alarms generally occurred across more trucks than less critical alarms.
2. Alarms per Truck per Month: The more critical alarms generally occurred less often; conversely, less critical alarms tended to occur more frequently.
3. Percentage of Alarms ‘Snoozed:’ Less critical alarms were ‘snoozed’ (or temporarily ignored) by system operators more often than critical alarms.
4. Conversion Rate: Critical alarms were more often associated with a subsequent ‘down’ event than less critical alarms (e.g., the percentage of mining machine 12 down time within 4 hours of the alarm)
5. Complete Annotations: More critical alarms tended to have more alarm annotations than less critical alarms.
   Other embodiments of the machine alarm classification system 10 may organize alarm criticality using more or fewer variables, depending on the number of relevant alarm characteristics.

The company then used a k-means clustering function to classify and group the alarms according to these five variables. The k-means clustering function sorted the alarms into the following five priority levels of importance, wherein alarms with high conversion rates and affecting more trucks per month—while also occurring less frequently and with low ‘snooze’ percentages-were grouped as high-criticality alarms, and vice-versa:

| Priority Level | Number of Alarms | Number of Alarm Occurrences |
|---|---|---|
| 1 (Highest) | 15 | 10,417 |
| 2 | 43 | 47,599 |
| 3 | 13 | 108,297 |
| 4 | 35 | 24,911 |
| 5 (Lowest) | 76 | 300,101 |

After grouping the alarms into five levels of criticality, the company determined the strength of each alarm annotation at method 22 step 30. First, null annotations were removed from the data set and the remaining annotations were organized by the level of completeness of their written annotations, with full written annotations being most preferable for generating useful classification data. Next, a sentiment analysis algorithm analyzed the annotations to determine their strength. The sentiment analysis algorithm assigned higher strength scores to alarms with a higher percentage of annotation completeness—that is, alarms with more extensive written comments and notes regarding the circumstances and effect of the alarm. The following table illustrates the resulting sentiment scores assigned to two differing alarm examples:

| Alarm Name | Alarm Comments | Sentiment Score | Strength |
|---|---|---|---|
| ENG COOL TEMP | Coolant Temp >230, | 30.64 | High |
| | Reduce Engine Load | | |
| REAR | N/A | 5.89 | Low |
| AFTERCOOLER | | | |
| TEMPERATURE | | | |

In this embodiment of the method 22, the sentiment analysis algorithm also generated word clouds depicting the words used in the alarm comments to assist with the visualization of particular word frequency and to highlight the most-used important words in each alarm annotation.

Having now grouped the alarms into five levels of criticality and determined the strength of the alarm annotations, the company used these two parameters to develop an alarm classification policy at method 22 step 30. Expert input machine operators reviewed the alarm criticality levels assigned by the k-means clustering function, and the annotation strengths assigned by the sentiment analysis algorithm, to determine their accuracy. The machine operators utilized the annotation word clouds created by the sentiment analysis algorithm to assist in this process. Whereas the original alarm classification system contained only ‘critical’ and ‘non-critical’ alarms, the final system resulted in five alarm condition categories: ‘critical,’ ‘warning,’ ‘operation-induced,’ ‘schedule maintenance,’ and ‘informational,’ in decreasing level of priority. The machine operators reclassified certain alarms based on the sum of their criticality and the strength of their annotations, e.g. moving a particular alarm initially classified as ‘critical’ to ‘schedule maintenance’ due to its low sentiment score and high frequency of alarm ‘snoozing.’ An iterative process of alarm classification review resulted in the final grouping of alarms into one of the five condition categories; other embodiments may arrive at a different number of final alarm condition categories at method 22 step 30, depending on the context and relevant variables of the particular embodiment.

In this example embodiment, the mining company's implementation of the machine alarm classification system 10 method 22 significantly reduced the number of alarm conditions requiring immediate attention, thereby relieving system operators of the heretofore significant burden of trying to understand the machine alarms and distinguish those alarm conditions requiring immediate attention from other alarm conditions of reduced priority. The newly-developed alarm classification policy reduced the number of alarms that qualified as ‘critical’ from 82 to 21, and the number of ‘warning’ alarms from 276 to 58. In an identical time period, the classification system 10 reduced the number of critical alarm occurrence events from 87,661 to 10,622, and warning alarm events from 430,869 to 118,350.

In a related embodiment, the original 82 alarm conditions deemed ‘critical’ were reclassified as follows based on the developed alarm classification policy:

| Alarm Category | Number of Alarms |
|---|---|
| Critical | 19 |
| Warning | 16 |
| Operation-Induced | 2 |
| Schedule Maintenance | 43 |
| Informational | 2 |

The application of the developed alarm classification policy to the original list of 87,661 critical alarm occurrences resulted in the following number of occurrences in each of the five new alarm condition categories:

| Alarm Category | Number of Occurrences |
|---|---|
| Critical | 9,779 |
| Warning | 25,396 |
| Operation-Induced | 4 |
| Schedule Maintenance | 45,178 |
| Informational | 7,304 |

This example embodiment of implementing a new alarm classification policy according to the teachings of the present invention rapidly produced new and relevant alarm classifications. it merged multiple sets of structured and unstructured data and reached a consensus with the expert input machine operators within two days of project initiation. Consequently, the new alarm classification policy accomplished its goals of reducing the number of critical alarms and non-critical, less relevant alarms while maintaining the quality of alarm reporting and still permitting important alarms to reach the attention of system operators.

Having herein set forth preferred embodiments of the present invention, it is anticipated that suitable modifications can be made thereto which will nonetheless remain within the scope of the invention. The invention shall therefore only be construed in accordance with the following claims:

1. A method of classifying machine alarms produced by a machine monitoring system, comprising:
collecting a plurality of machine alarms from the machine monitoring system, the machine alarms being indicative of out-of-range machine system parameters of the machine;
collecting a plurality of alarm annotations associated with at least some of the machine alarms;
grouping the plurality of machine alarms by criticality;
determining a strength of alarm annotations; and
developing an alarm classification policy for machine alarms based at least on the criticality of the alarms and the strength of the alarm annotations.

2. The method of claim 1, wherein said grouping comprises subjecting the collected machine alarms to a k-means clustering algorithm.

3. The method of claim 1, wherein said alarm annotations comprise text annotations and wherein said determining comprises assigning a sentiment score to the collected alarm annotations based on the text of the alarm annotations.

4. The method of claim 3, wherein said assigning a sentiment score to the collected alarm annotations comprises assigning a high sentiment score to alarm annotations deemed to be of a significant strength and assigning a low sentiment score to alarm annotations deemed to be of a weak strength.

5. The method of claim 3, further comprising subjecting the text of the alarm annotations to a word cloud analysis algorithm to determine the frequencies of words used in the alarm annotations, and using the word cloud analysis to refine the sentiment score.

6. The method of claim 1, further comprising performing a word cloud analysis on the alarm annotations and wherein said classifying further comprises classifying the plurality of machine alarms based on the criticality of the alarms, the strength of the alarm annotations, and the word cloud analysis.

7. The method of claim 1, wherein said developing the alarm classification policy comprises developing an alarm classification policy having five alarm condition categories.

8. The method of claim 7, wherein said developing an alarm classification policy having five alarm condition categories comprises developing an alarm classification policy having a ‘critical’ category, a ‘warning’ category, an ‘operational induced’ category, a ‘schedule maintenance’ category, and an ‘informational’ category.

9. A non-transitory computer-readable storage medium having computer-executable instructions embodied thereon that, when executed by at least one computer processor cause the processor to:
collect a plurality of machine alarms from the machine monitoring system, the machine alarms being indicative of out-of-range machine system parameters of the machine;
collect a plurality of alarm annotations associated with at least some of the machine alarms;
group the plurality of machine alarms by criticality;
determine a strength of alarm annotations; and
develop an alarm classification policy for machine alarms based at least on the criticality of the alarms and the strength of the alarm annotations.

10. A method of operating a machine having a machine monitoring system that produces machine alarms indicative of out-of-range machine system parameters, comprising:
receiving machine alarms from the machine monitoring system;
classifying the machine alarms based on a predetermined alarm classification policy for the machine, the predetermined alarm classification policy being based on criticality of representative samples of machine alarms and strength of representative samples of alarm annotations; and
managing the subsequent operation of the machine based on the reclassified machine alarms.

11. A system for classifying machine alarms produced by a machine monitoring system, comprising:
a network;
a machine monitoring system operatively connected to said network;
a processing system operatively associated with said network; and
a display system operatively associated with said processing system, wherein said processing system is configured to:
receive machine alarms from the machine monitoring system, the machine alarms being indicative of out-of-range machine system parameters of the machine;
classify the machine alarms based on a predetermined alarm classification policy, the predetermined alarm classification policy being based on criticality of representative samples of machine alarms and strength of representative samples of alarm annotations; and
display the classified machine alarms on the display system.

12. A non-transitory computer-readable storage medium having computer-executable instructions embodied thereon that, when executed by at least one computer processor cause the processor to:
receive machine alarms from a machine monitoring system, the machine alarms being indicative of out-of-range machine system parameters of a machine;
classify the machine alarms based on a predetermined alarm classification policy, the predetermined alarm classification policy being based on criticality of representative samples of machine alarms and strength of representative samples of alarm annotations; and
display the classified machine alarms on the display system.
